(19) United States
(12) Patent Application Publication
(10) Pub. No.: US 2006/0243934 A1
(43) Pub. Date: Nov. 2, 2006

(54) Methods and devices for modulating fluid flow in a micro-fluidic channel

(76) Inventors: Bradley D. Chung, Corvallis, OR (US); Edward Enciso, Corvallis, OR (US); Philip Harding, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,133

(22) Filed: Apr. 28, 2005

(51) Int. Cl. F16K 31/18

(52) U.S. Cl. 251/11

(57) ABSTRACT

The present invention is drawn to a method for modulating fluid flow in a micro-fluidic channel, comprising the step of applying heat to a valve of a micro-fluidic channeling device. The valve can include an elastically resilient portion having a first configuration prior to application of heat and a second configuration after application of heat. In one aspect, the first configuration provides an open valve configuration and the second configuration provides a closed valve configuration. In another aspect, the first configuration provides a closed valve configuration and the second configuration provides an open valve configuration.

### FIELD OF THE INVENTION

The present invention is drawn to devices and methods for modulating fluid flow. In particular, the invention is related to systems and methods which modulate fluid flow in a micro-fluidic channel.

### BACKGROUND OF THE INVENTION

Micro-fluidic devices are used in many applications, such as in medical treatment, industrial process control, ink-jet applications, chemical and biological processes, biomedical analysis, and micro-chemical reactions. Particularly, chemical processes and analyses rely upon micro-fluidic transport mechanisms to manipulate fluid in a particular timing and sequencing regime to achieve a precise analysis of chemical assays. In many of the aforementioned processes, implementation of micro-fluidic devices are desirable to mix, react, measure, separate, dilute, and/or transport small volumes of fluid. Quantity, timing, and sequencing can play a vital part in accomplishing and carrying out functions of the desired systems. As such, there has been an increased interest and research related to developing micro-fluidic devices that are able to manipulate fluid flow.

A number of approaches have been disclosed for modulating and manipulating fluid flow. One such approach is applying mechanical valves or devices to either induce or impede fluid flow in micro-fluidic channels. For example, an electromechanical or pneumatic-mechanical micro-fluidic actuator or solenoid has often been employed in many micro-channeling apparatuses to manipulate and deliver desired fluid flows to the micro-technology systems. However, there are several disadvantages that arise when utilizing micro-mechanical type valves. Generally, mechanical valves are developed on a micro scale leading to micro-sized moving parts. As micro-mechanical valves must decrease in size due to the demand for even smaller devices, it becomes difficult to provide cost efficient and simplistic fabrication processes. Maintenance, service, and longevity of use become other major factors with respect to micro-mechanical valves.

Another type of valve or device often incorporated into micro-technology is the electronic actuated valve. Normally, these types of valves, such as piezoelectric actuated micro-valves, lack small moving parts. The piezoelectric micro-valve generally consists of several piezoelectric disks stacked and in communication with a flexible diaphragm. To make the diaphragm expand or contract, voltage is applied across the stack of piezoelectric discs causing the stack to contract into a compressed condition, lifting the diaphragm, thereby creating a narrow opening in a micro-fluidic channel. However, these piezoelectric discs are complex and not particularly cost efficient.

A more simple type of valve utilizes wax, which is injected into a channel or conduit to provided blockage or restriction of fluid flow. In order to obtain fluid flow, the wax material is heated and liquefied allowing for freely moving fluid flow. This type of fluid flow manipulation does not require moving parts. However, one complication is the removal of the wax material entirely without contaminating the fluid.

However, not all of the above described processes provide a cost efficient and reliable system for manipulating fluid flow in a micro-fluidic device. Further, most of the aforementioned processes are continuous fluid flow modulating methods. Thus, there is still a need for a micro-fluidic channeling device that is simple and effective for broad application toward micro-fluidic transportation.

### BRIEF DESCRIPTION OF THE DRAWINGS

FIGS. 1a to 1c provide a schematic diagram illustrating various stages of a micro-fluidic channeling device according to an embodiment of the present invention;

FIGS. 2a to 2d provide a schematic diagram illustrating various stages of a micro-fluidic channeling device according to an alternative embodiment of the present invention; and

FIGS. 3a to 3d provide a schematic diagram illustrating various stages of a micro-fluidic channeling device according to another embodiment of the present invention.

### DETAILED DESCRIPTION OF THE PREFERRED EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features, process steps, and materials illustrated herein, and additional applications of the principles of the inventions as illustrated herein, which would occur to one skilled in the relevant art and having possession of this disclosure, are to be considered within the scope of the invention. It should also be understood that terminology employed herein is used for the purpose of describing particular embodiments only and is not intended to be limiting.

In describing and claiming the present invention, the following terminology will be used.

The singular forms “a,” “an,” and “the” include plural referents unless the context clearly dictates otherwise. Thus, for example, reference to “a pinch-point” includes reference to one or more of such pinch-points.

The term “about” when referring to a numerical value or range is intended to encompass the values resulting from experimental error that can occur when taking measurements.

The term “micro-fluidic” means any mechanism that is in relation to or controls small volumes of fluid, e.g., less than a microliter (μl) of fluid. The term “channel” means any hollow tubular structure or conduit capable of transporting or communication of a fluid (gas or liquid) from one place to another. The hollow tubular conduit can be formed in any geometric configuration, e.g. circular, oval, square, triangular, etc.

The term “elastically resilient portion” refers to any part of a micro-valve that can have a first configuration and a second configuration. Modification from the first configuration to the second configuration can be carried out by applying heat, and optionally, pressure. In some embodiments, the elastically resilient portion can contribute to an open valve in a first configuration and a closed or more restrictive valve in a second configuration. In other embodiments, the elastically resilient portion can contribute to a closed or more restrictive valve in a first configuration and an open valve in a second configuration.

The term “pinch-point” refers to one type of valve configuration, and includes any location or region where a fluid is being bound, squeezed, crimped, or restricted from continuous flow, including restriction from minimal flow restriction to complete restriction of flow.

The term “write-once” means a one-time application procedure. For example, application of heat to the pinch-point valve actuates the valve one time thermally.

The presently claimed invention is drawn towards a device and method for modulating fluid flow in a micro-fluidic channeling device. In accordance with this recognition, the present invention is drawn to a method for modulating fluid flow in a micro-fluidic channel, comprising the step of applying heat to a valve of a micro-fluidic channeling device. The valve can include an elastically resilient portion having a first configuration prior to application of heat and a second configuration after application of heat. In one aspect, the first configuration provides an open valve configuration and the second configuration provides a closed valve configuration. In another aspect, the first configuration provides a closed valve configuration and the second configuration provides an open valve configuration.

The formation of an elastically resilient pinch-point can be used to favorably illustrate embodiments of the present invention. In accordance with this exemplary embodiment, the method of the present invention can provide a micro-fluidic channeling device which modulates and increases fluid flow by application of heat to an elastically resilient pinch-point valve. The elastically resilient pinch-point valve can be configured to restrict fluid flow; however, upon application of heat, the configuration of the valve changes, thereby increasing fluid flow. Typically, the elastically resilient pinch-point valve can be fabricated in a closed or restrictive configuration prohibiting continuous fluid flow. The closed configuration is ideal for transporting a fluid sample from one location to another or for storing a fluid sample. Fluid flow can be increased when heat is applied to the pinch-point valve, thereby restoring the pinch-point to a more open configuration. The fluid itself can provide positive pressure from within the tube to open the channel upon application of heat. Alternatively or additionally, negative pressure can also be applied to the pinch-point during application of heat such that the channel can more fully open, thereby causing fluid flow to increase.

A preliminary step of forming or fabricating an elastically resilient pinch-point valve is also provided by applying a sufficient amount of heat and pressure in a discrete location along the micro-fluidic channeling device or tube thereby forming the pinch-point. The heat and pressure can act to transform the inner walls of the channeling device in a manner sufficient to create a node, bulge, or an elastically resilient pinch-point valve which can be configured to regulate, restrict, or substantially restrict fluid flow. The pressure can be maintained until the micro-fluidic channeling device cools, thus maintaining the newly formed configuration. The amount of flow restriction depends on the amount of external stimuli, e.g., heat or pressure, being exerted on the device and/or internal stimuli, e.g., fluid pressure, exerted on the fluid flowing through the device.

Another aspect of the present invention is drawn towards a micro-fluidic channeling device having a valve containing at least one elastically resilient portion configured to restrict fluid flow. Alternatively, as noted, the elastically resilient portion can also be configured to increase fluid flow upon the application of heat to the area where the elastically resilient portion is located. This can be carried out using an elastically resilient pinch-point, as discussed previously, or by some other design in accordance with embodiments of the present invention.

The present device is optimal for various micro-fluidic systems where mixing and timing are essential, such as chemical analysis systems, in medical treatment, industrial process control, biomedical/pharmacological analysis, and micro-chemical reactions, or in any system or process that requires the mixing, reacting, measuring, separating, diluting, and/or transporting small volumes of fluid. Often times, micro-fluidic products are fabricated for systems which require the ability to open or close a fluidic channel on a one-time or “write-once” basis. For example, many systems require a variety of fluids to be micro-mixed at predetermined times via fluidic channels such as with a pharmacological assay. Pharmacological assay analysis utilizes deposited fluids to be timed and synchronized with mixing fluids, thus allowing for a precise analysis. This type of application can benefit from the present invention, in that the channeling device of the present invention can generally transport or deliver small volumes of fluid, e.g., from femtoliter to μl quantities, and do so precisely. The present invention may also be adapted to transport quantities of fluid larger than μl quantities.

The elastically resilient memory materials that can be used in accordance with embodiments of the present invention can be highly deformed and stretched into different shapes when heated above the glass transition temperature. Typically, elastically resilient material or composites also have the ability to remember and regain an original shape configuration. This material is often referred to as “shape memory” material, polymers, or composites. Shape memory composites or polymers demonstrate a physical memory property which is exhibited best by materials whose glass transition temperature is marginally higher than room temperature, and which transition from glass to elastic is particularly quick. When held in the desired shape and cooled, the newly formed material retains the new shape indefinitely. In this case, energy may be stored in the material as stress. Reheating the material above its glass transition temperature generally relieves the material from this stressed condition, and thus, allows the material to revert back to its more equilibrated or even its original shape.

The present invention utilizes the properties of a shape memory material to form a tubular structure which can be heated, deformed, and then later reformed to its original or near original shape by simply heating the material above the glass transition temperature. The elastically resilient material of the micro-fluidic channeling device can be of any material that has a memory; however, materials that are particularly useful include polyimides, polymethylmethacrylates (PMMA), polystyrene, and mixtures thereof. In an exemplary embodiment, the micro-fluidic channeling device can be formed from a polyimide composition. Typical glass transition temperature ranges for the selected polymers and mixtures are generally from about 100° C. to about 220° C. Polystyrene can have a glass transition temperature of about 100° C. This being stated, the micro-channeling device of the present embodiment may also be fabricated from any material having elastomeric properties which respond well to heat and pressure stimuli in accordance with embodiments of the present invention. In one embodiment of the present invention, the elastically resilient portion of the micro-fluidic device can be heated to at least the glass transition temperature of the shape memory material. In another embodiment, the micro-fluidic device can be heated at from 1° C. to 50° C. above the glass transition temperature of the material. In yet another embodiment, the elastically resilient portion can be heat to about 20° C. above the glass transition temperature. Heat can be applied to the presently claimed invention through various means such as, a hot plate, a laser, or any composition, structure, or energy source capable of disseminating heat.

In an alternative embodiment, a micro-fluidic channeling device can include a micro-fluidic tube formed from materials other than shape memory materials, such as polyvinyl chloride, polyurethane, polyethylene, polypropylene, nylon, polycarbonate, butyrate, glycolised polyester (e.g., PETG) propionate, thermoplastic terpolymers of acrylonitriles and butadienes (e.g., ABS), etc. In this embodiment, the micro-fluidic tube may include a valve having at least one elastically resilient portion. The elastically resilient portion can then be deformed in any manner desired through heat and pressure. For example, a portion of a valve may be deformed to a configuration such that the valve is open, and when heat is applied to the deformed portion, the portion expands and closes the valve, as will be shown by example hereinafter. This configuration can be used to modulate fluid flow while the micro-fluidic tube substantially retains it original configuration in order to provide a channel for transporting fluid.

Reference will now be made to the drawings in which the various elements of the present invention will be given numeral designations and in which the invention will be discussed. It is to be understood that the following description is only exemplary of the principles of the present invention, and should not be viewed as narrowing the appended claims.

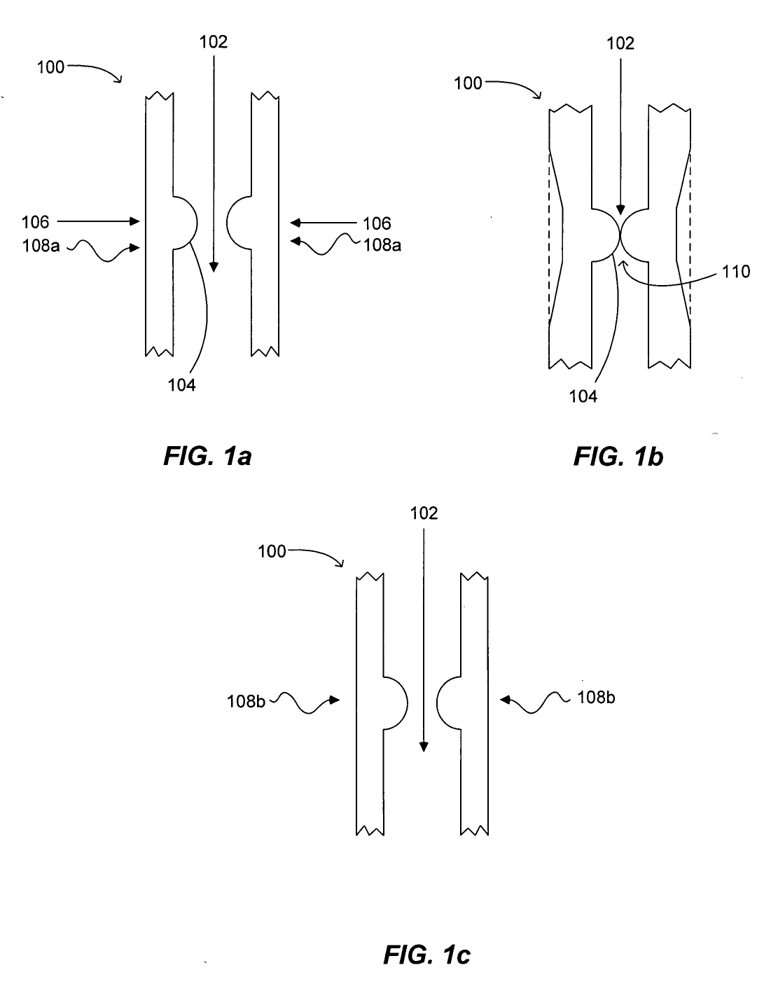

Referring now to FIGS. 1a to 1c, an elastically resilient or memory material can be utilized in forming a micro-fluidic channeling device 100. The micro-fluidic channeling device can be formed in a cylindrical tube or conduit shape having an initial open configuration (FIG. 1a), a heat- and pressure-induced closed configuration (FIG. 1b), and a heat-induced re-opened configuration (FIG. 1c). The micro-fluidic channeling device can be formed, in cross-section perpendicular to the direction of fluid flow 102, as a cylindrical or circular shape, a triangular shape, an oval shape, or a square or rectangular tubular shape, for example. In this embodiment, the open or closed configuration is determined by the distance between the protrusions, nodes or bulges 104 that can be present to create the elastically resilient pinch-point 110. When a micro-fluidic channeling device is in an open configuration, the elastically resilient pinch-point defines a space or gap such that fluid flow is from relatively to completely unimpeded and continuous. If a micro-fluidic channeling device is in a closed configuration, then the nodes are in a more proximate position with respect to each other, thereby forming a pinch-point. The pinch-point acts to reduce, restrict, or eliminate fluid flow.

To form the pinch-point 110 shown in FIG. 1b, application of heat 108a, and optionally pressure 106, to a discrete location at or around the location of the nodes can provide acceptable results. Because of the nodes 104, pressure may not be required to form the pinch-point, as the material may swell such that the nodes are brought closer together, though it is usually preferred to apply some pressure. As noted above, once the material achieves and/or surpasses the glass transition temperature, it becomes ductile and pliable. The addition of heat and pressure in the discrete location forms the restrictive pinch-point from the micro-fluidic channeling device wall. Sufficient pressure can be applied through any solid or rigid tool which is capable of deforming the ductile elastomeric material from an open configuration to a more restrictive configuration. The solid tool can be any number of items, for example and without limitation, a pair of screw drivers, pliers, rubber shoes, blunt or sharp instruments, etc. The amount of pressure applied can be in the range from about 0.1 psi to about 150 psi, though any functional amount of pressure can be used. Again, as previously mentioned, the heat applied is relative to the glass transition temperature of the micro-tube material. In another embodiment, pressure and heat can be applied through the same solid member. For example two solid metallic members may apply pressure to a discrete location on a micro-fluidic channeling device while being simultaneously heated to at least the glass transition temperature of the material.

Once the micro-channel has been restricted by the sequential application and withdrawal of heat, and optionally pressure, the channel can be re-opened by the application of additional heat 108b. Additionally, negative external pressure may be applied to a closed pinch-point configuration to ease the reformation process of the micro-fluidic device, or alternatively, the fluid pressure from within the channel can also aid in re-opening the pinch-point upon application of heat.

The closed configuration shown in FIG. 1b can be ideal for storing and shipping a desired fluid without having fluid flow or leakage. Thus, in one aspect of the invention, a device that is pre-formed in a closed configuration can be loaded with a liquid. The pinch-point 110 of the device can thus be poised to elastically open upon application of heat, thereby releasing or allowing fluid flow 102. It should be noted that when forming the pinch point, in an embodiment, complete melting of the material should not occur. This is because if complete melting of the material occurs, the pinch point will lose its stored energy or elasticity, and thus, will not elastically reopen when subsequent heat is applied. Thus, when forming the pinch point, the heat and pressure should be great enough to create the pinch point, but should be less than the amount of heat and/or pressure that would permanently reconfigure the pinch point so that it loses it elasticity. This being stated, as shown in FIG. 1c, upon application of heat 108b, the resilient material becomes reconfigured to restore or substantially restore the pinch point and allow fluid flow 102. In other words, when heat is applied to the pinch point, the pinch point can be reopened, restoring fluid flow.

In accordance with one embodiment, the systems described herein can be configured such that the fluid delivery is a one-time event. Thus, a one-time or “write-once” device can be prepared. In other words, a write-once device can be prepared such that the fluid channeling device modulates fluid flow one time, wherein the device is initially presented in a closed configuration, and can be readily reverted back to an open configuration upon the application of a stimuli, e.g. heat.

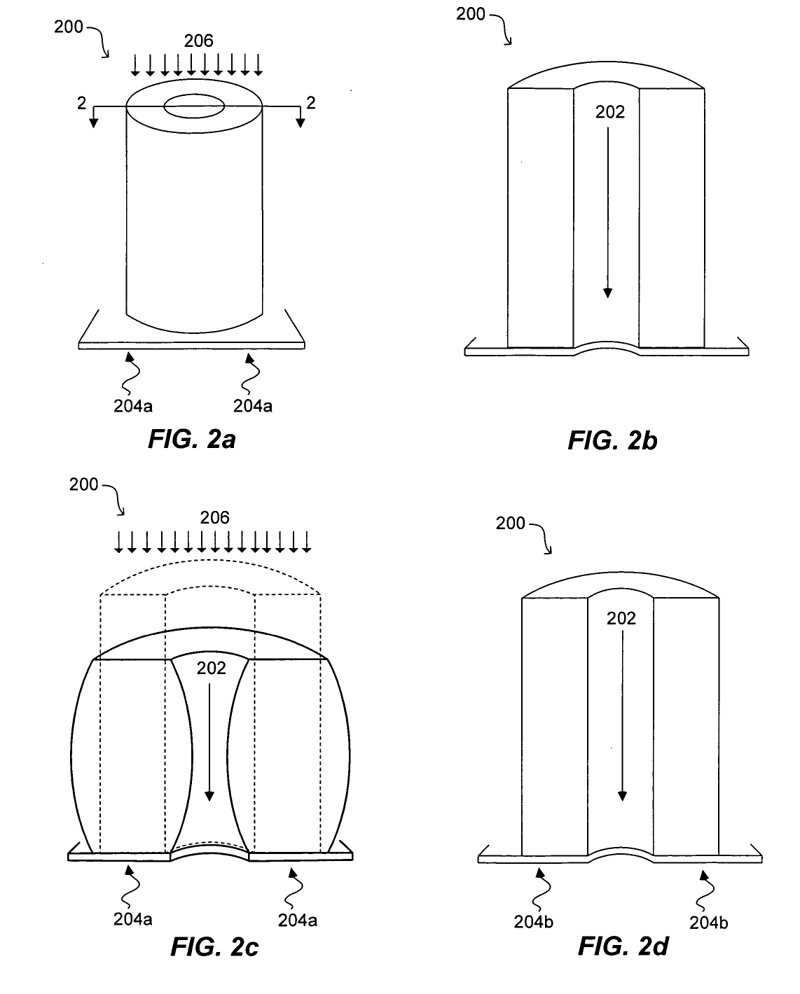

Referring now to FIGS. 2a-2d, an elastically resilient material can be formed into a micro-fluidic channeling device 200, which is viewed in FIGS. 2b-2d in cross-section taken along line 2-2 as shown in FIG. 2a. Notably, the channeling device of FIGS. 2a-2d are similar to the channeling device of FIGS. 1a-1c, with an exception being the direction from which the pressure is to be applied to form the pinch-point. Device 200 has an initial open configuration (FIG. 2b), a closed or partially closed configuration (FIG. 2c) which restricts fluid flow 202, and a re-opened configuration (FIG. 2d) which allows for or restores fluid flow. In this embodiment, a pinch-point can be prepared by applying a sufficient amount of heat 204a to the device to achieve or exceed its glass transition temperature. Additionally, a uniform amount of pressure 206 can applied to the ends of device, thereby deforming the device and creating a bulge or protrusion into the path of the fluid flow, thereby restricting the fluid flow. Upon cooling, the device can harden or solidify and substantially retain its newly formed shape indefinitely. As shown in FIG. 2d, heat 204b can then be subsequently applied to device to revert the micro-fluidic channeling device back to an open configuration.

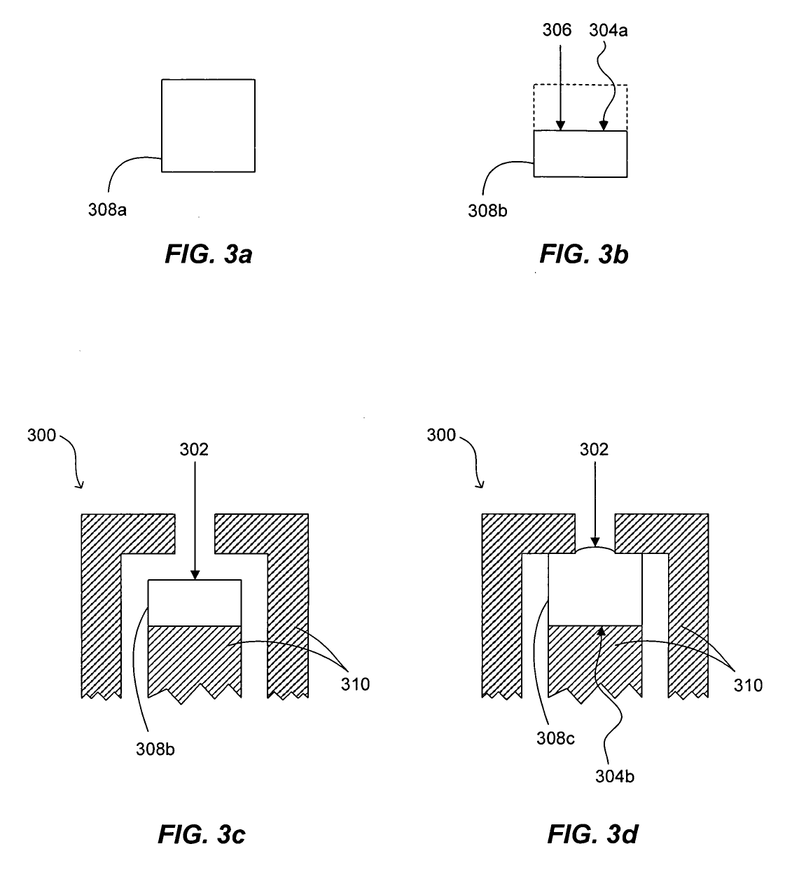

Referring now to FIGS. 3a-3d, a micro-fluidic channeling device can include a valve or valve region 300 having at least one elastically resilient portion 308a, b, and c, for modulating fluid flow. The elastically resilient portion, may be prepared in its original or equilibrium configuration (FIG. 3a), then converted to a compressed configuration induced by heat 304a and pressure 306 (FIG. 3b). The micro-fluidic device can also include a micro-fluidic tube 310 fabricated from any material that will retain its shape while the elastically resilient portion is heated to close the valve, as will be discussed below.

Typically, the micro-fluidic tube 310 is configured to contain or is part of a valve region 300 having an elastically resilient portion prepared in a compressed configuration 308b as shown in FIG. 3c. The compressed valve may be fabricated from any shape memory material that has previously been described, or any other functional shape memory material. Notably, compressing the elastically resilient portion can be accomplished by first heating 304a the shape memory material and subsequently or simultaneously applying a sufficient amount of pressure 306, as depicted in FIG. 3b. Upon cooling, the elastically resilient portion can solidify and substantially retain a compressed shape indefinitely, while maintaining an elastic potential that will expand when subsequently appropriately heated. After forming the elastically resilient portion in a compressed state, as shown in FIG. 3b, the elastically resilient portion can be inserted into the micro-fluidic tube, as shown in FIG. 3c. Alternatively, the elastically resilient portion can be compressed after placing the resilient portion appropriately within the tube.

Once the valve region 300 of the micro-fluidic channeling device is formed with the elastically resilient portion 308b configured in its compressed configuration, fluid flow 302 can be relatively continuous and unimpeded. In order to modulate or restrict fluid flow, application of additional heat 304b to the elastically resilient portion can be carried out. As previously mentioned, once the elastically resilient portion reaches its glass transition temperature, the elastically resilient portion is reshaped to approximately its original configuration 308c. In the present embodiment, the elastically resilient portion is positioned such that it can seal the micro-channel and impede fluid flow, as shown in FIG. 3d.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

### Preparing a Micro-Fluidic Channeling Device

A micro-fluidic channeling device in the form of a 14 μm channeling tube is prepared using a shape memory polyimide polymer having a glass transition temperature of approximately 180° C. Next, a pinch-point is added to a discrete section of the channeling device by first applying pressure to the discrete area of the tube with a rubber shoe having a 25 μm sheet of DuPont's Kapton® polymer inserted between the rubber shoe and the tube. Once in this deformed position, a hot plate is used to raise the temperature of the tube to approximately 220° C., or about 40° C. above the glass transition temperature. Subsequently, while still maintaining pressure, the temperature of the device is decreased to at least below the glass transition temperature, causing the shape memory material to be elastically held in a pinched configuration. Analysis is performed through an optical microscope, verifying the formation of a restrictive pinch-point of the device.

### Example 2

### Modulating Fluid Flow Using a Micro-Fluidic Channeling Device

The device of Example 1 is filled with a fluid having a low surface tension and a boiling point significantly higher than water. The device is tested to ensure that the pinch-point indeed prevents the fluid from escaping through the pinch-point. The device is then reheated above the glass transition temperature to about 220° C. in the absence of pressure. As the device reverts back to its original shape, the fluid begins to flow through the channeling device where the pinch-point once was present. An optical microscope can be used to confirm that the device substantially recovers to its original shape.

### Example 3

### Preparing a Micro-Fluidic Channeling Device

A micro-fluidic device such as one used for transporting fluids in pharmacological assays is prepared. The micro-fluidic channeling device has a cross sectional area of 500 μm×500 μm with a 1.5 mm thick wall. The micro-fluidic channeling device is produced from a polymethylmethacrylate (PMMA) material having a glass transition temperature of approximately 105° C.

The device is heated, on a hot plate, above its glass transition temperature of 105° C., preferably to about 150° C. A pair of flat solid composite tools is used, such as two flat-headed screw drivers, to apply pressure inward on the sides of the device, thus forming an elastically resilient pinch-point upon cooling. Once sufficiently cooled, the tools are removed, leaving a pinch-point. Faster cooling can be carried out by applying water, for example. The micro-fluidic channeling device is restored to its original shape by re-applying heat to the device. This is done by placing the micro-fluidic channeling device on a 150° C. hotplate. The device reverts back to its original shape within seconds of applying heat.

1. A method for modulating fluid flow in a micro-fluidic channel, comprising the step of:
applying heat to a valve of a micro-fluidic channeling device, said valve including an elastically resilient portion having a first configuration prior to application of heat and a second configuration after application of heat, wherein
i) the first configuration provides an open valve configuration and the second configuration provides a closed valve configuration, or
ii) the first configuration provides a closed valve configuration and the second configuration provides an open valve configuration.

2. The method of claim 1, wherein the first configuration provides the open valve configuration and the second configuration provides the closed valve configuration.

3. The method of claim 1, wherein the first configuration provides the closed valve configuration and the second configuration provides the open valve configuration.

4. The method of claim 1, wherein the micro-fluidic channeling device is a micro-fluidic tube.

5. The method of claim 3, wherein the closed valve configuration is in the form of an elastically resilient pinch-point being configured to restrict fluid flow, said heat causing the pinch-point to change in configuration such that fluid flow is increased.

6. The method of claim 5, wherein the step of applying heat further includes applying pressure to the pinch-point.

7. The method of claim 6, wherein the pressure is provided by the fluid flow within the micro-fluidic channeling device.

8. The method of claim 6, wherein the pressure is provided by external negative pressure applied to the pinch-point.

9. The method of claim 5, further comprising the preliminary step of forming the elastically resilient pinch-point by applying heat and pressure to the micro-fluidic channeling device at a discrete location along the micro-fluidic channeling device, and then withdrawing the heat and pressure, thereby leaving the elastically resilient pinch-point.

10. The method of claim 9, wherein the pressure is applied by a solid tool.

11. The method of claim 10, wherein the solid tool includes a rubber portion configured to contact the discrete location.

12. The method of claim 9, wherein the pressure is applied in an amount from about 0.1 psi to about 150 psi.

13. The method of claim 10, wherein the solid tool is also configured to apply the heat to the discrete location.

14. The method of claim 9, wherein the heat and pressure applied is sufficient to deform the micro-fluidic channeling device from an open configuration to a more restrictive configuration.

15. The method of claim 14, wherein the more restrictive configuration is a closed configuration.

16. The method of claim 1, wherein the elastically resilient portion is formed from a material selected from a group consisting of polyimide, polymethylmethacrylate, polystyrene, and mixtures thereof.

17. The method of claim 16, wherein the elastically resilient portion is formed from a polyimide.

18. The method of claim 1, wherein the elastically resilient portion comprises a polymeric material having a glass transition temperature, said elastically resilient portion being heated to at least the glass transition temperature of the polymeric material.

19. The method of claim 18, wherein the elastically resilient portion is heated at from 1° C. to 50° C. above the glass transition temperature of the material.

20. The method of claim 1, wherein the method for modulating flow is a write-once method.

21. A micro-fluidic channeling device, comprising at least one elastically resilient portion, said portion being configured to restrict fluid flow in a first configuration, and further being configured to allow increased fluid flow in a second configuration upon application of heat to the portion.

22. The micro-fluidic channeling device of claim 21, wherein the micro-fluidic channeling device is a micro-fluidic tube.

23. The micro-fluidic channeling device of claim 21, wherein the elastically resilient portion is an elastically resilient pinch-point.

24. The micro-fluidic channeling device of claim 23, wherein the elastically resilient pinch-point is formed by applying heat and pressure to the micro-fluidic channeling device at a discrete location along the micro-fluidic channeling device.

25. The micro-fluidic channeling device of claim 23, wherein the elastically resilient pinch-point is configured to allow increased fluid flow upon application of heat and pressure to the pinch-point.

26. The micro-fluidic channeling device of claim 21, wherein the elastically resilient portion is formed from a material selected from a group consisting of polyimide, polymethylmethacrylate, polystyrene, and mixtures thereof.

27. The micro-fluidic channeling device of claim 26, wherein the elastically resilient portion is formed from the polyimide.

28. The micro-fluidic channeling device of claim 21, wherein the elastically resilient portion comprises a polymeric material having a glass transition temperature, said elastically resilient portion being configured to allow increased fluid flow upon application of heat to at least the glass transition temperature of the material.

29. The micro-fluidic channeling device of claim 28, wherein the elastically resilient pinch-point is configured to allow increased fluid flow upon application of heat at from 1° C. to 50° C. above the glass transition temperature of the material.

30. The micro-fluidic channeling device of claim 21, wherein when the pinch-point is configured to restrict fluid flow, the pinch-point is in a closed configuration.

31. The micro-fluidic channeling device of claim 21, wherein the micro-fluidic channeling device is a write-once device.

32. The micro-fluidic channeling device of claim 21, said device being configured for at least one of chemical analysis, biomedical analysis, and ink-jet printing.

33. A micro-fluidic channeling device, comprising at least one elastically resilient portion, said portion being configured to allow fluid flow in a first configuration, and further being configured to restrict fluid flow in a second configuration upon application of heat to the portion.

34. The micro-fluidic channeling device of claim 33, wherein the micro-fluidic channeling device is a micro-fluidic tube.

35. The micro-fluidic channeling device of claim 33, wherein the elastically resilient portion is formed from a material selected from a group consisting of polyimide, polymethylmethacrylate, polystyrene, and mixtures thereof.

36. The micro-fluidic channeling device of claim 35, wherein the elastically resilient portion is formed from the polyimide.

37. The micro-fluidic channeling device of claim 33, wherein the elastically resilient portion comprises a polymeric material having a glass transition temperature, said elastically resilient portion being configured to restrict fluid flow upon application of heat to at least the glass transition temperature of the material.

38. The micro-fluidic channeling device of claim 37, wherein the elastically resilient portion is configured to decrease fluid flow upon application of heat at from 1° C. to 50° C. above the glass transition temperature of the material.

39. The micro-fluidic channeling device of claim 33, wherein when the elastically resilient portion is configured to restrict fluid flow, the elastically resilient portion provides a closed configuration.

40. The micro-fluidic channeling device of claim 33, wherein the micro-fluidic channeling device is a write-once device.

41. The micro-fluidic channeling device of claim 33, said device being configured for at least one of chemical analysis, biomedical analysis, and ink-jet printing.
